(19) United States
(12) Patent Application Publication
(10) Pub. No.: US 2026/0367787 A1
(43) Pub. Date: Nov. 19, 2026

(54) TECHNIQUES FOR GENERATING COMPRESSED ADDRESS MAPPING TABLES IN A MEMORY SYSTEM

(71) Applicant: Micron Technology, Inc., Boise, ID (US)

(72) Inventors: Wenjun Wu, Shanghai (CN); Deping He, Boise, ID (US); Caixia Yang, Boise, ID (US); Feng Xu, Shanghai (CN); Giuseppe Cariello, Boise, ID (US); Roberto Izzi, Caserta (IT)

(21) Appl. No.: 19/669,631

(22) Filed: May 6, 2026

Related U.S. Application Data
(60) Provisional application No. 63/808,287, filed on May 19, 2025.

(51) Int. Cl. G06F 3/06

(52) U.S. Cl. CPC G06F 3/0608; G06F 3/0659; G06F 3/0679

(57) ABSTRACT

Methods, systems, and devices for techniques for generating compressed address mapping tables in a memory system are described. A memory system may receive a first set of commands and a second set of commands that are interspersed with the first set of commands, the first set of commands associated with a set of sequential logical addresses. Due to the first set of commands being associated with the set of sequential logical addresses, the memory system may write, before writing second data associated with the second set of commands, first data associated with the first set of commands to a set of sequential physical addresses. The memory system may generate, in response to writing the first data to the set of sequential physical addresses, a compressed version of an address mapping table associated with the set of sequential logical addresses associated with the first set of commands.

### CROSS REFERENCE

The present Application for Patent claims priority to U.S. Patent Application No. 63/808,287 by Wu et al., entitled “TECHNIQUES FOR GENERATING COMPRESSED ADDRESS MAPPING TABLES IN A MEMORY SYSTEM,” filed May 19, 2025, which is assigned to the assignee hereof, and which is expressly incorporated by reference in its entirety herein.

### TECHNICAL FIELD

The following relates to one or more systems for memory, including techniques for generating compressed address mapping tables in a memory system.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports techniques for generating compressed address mapping tables in a memory system in accordance with examples as disclosed herein.

FIG. 2 shows an example of a memory system that supports techniques for generating compressed address mapping tables in accordance with examples as disclosed herein.

FIG. 3 shows an example of commands that support techniques for generating compressed address mapping tables in a memory system in accordance with examples as disclosed herein.

FIG. 4 shows an example of a scheduler that support techniques for generating compressed address mapping tables in a memory system in accordance with examples as disclosed herein.

FIG. 5 shows an example of a process flow that supports techniques for generating compressed address mapping tables in a memory system in accordance with examples as disclosed herein.

FIG. 6 shows a block diagram of a memory system that supports techniques for generating compressed address mapping tables in accordance with examples as disclosed herein.

FIGS. 7 and 8 show flowcharts illustrating a method or methods that support techniques for generating compressed address mapping tables in a memory system in accordance with examples as disclosed herein.

### DETAILED DESCRIPTION

A memory system may use an address mapping table (e.g., a physical page translation (PPT) level three (PPT3) table) to perform address translation between logical addresses (e.g., logical block addresses (LBAs)) and physical addresses (e.g., physical page addresses). For example, the address mapping table may map a set of sequential logical addresses (beginning with a starting logical address associated with that address mapping table) to physical addresses of a memory array. To enable access operations for the memory array, the memory system may load the address mapping table from persistent (e.g., non-volatile) storage into a local memory where a controller for the memory system can use the address mapping table to perform address translation. Due to the size of the address mapping table, loading the address mapping table and performing address translation using the address mapping table may take a long time, thus increasing the latency (e.g., read latency) of the memory system. The latency issue may be exacerbated when reading large data sets (e.g., 8GB), such as those associated with artificial intelligence (AI) applications, that are associated with many address mapping tables.

According to the techniques described herein, the latency (e.g., read latency) of a memory system may be reduced, relative to other techniques, by writing data to the memory system in a manner that allows the address mapping table to be compressed (e.g., reduced in size). For example, the memory system may group incoming commands from a host system into different sets (or “threads”) and strategically issue commands from the threads so that commands associated with sequential logical addresses are written to sequential physical addresses, even if such commands are interspersed with commands associated with non-sequential addresses. After writing the data associated with the sequential logical addresses for an address mapping table, the memory system may write the data associated with the non-sequential addresses. Such a technique may ensure that the data associated with sequential logical addresses is written to sequential physical addresses, thus enabling compression of the address mapping table.

In addition to applicability in memory systems as described herein, techniques for compressing address mapping tables may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by improving memory access speeds, which may decrease processing or latency times, improve response times, or otherwise improve user experience, among other benefits.

Features of the disclosure are illustrated and described in the context of systems, devices, and circuits. Features of the disclosure are further illustrated and described in the context of commands diagrams, process flows, and flowcharts.

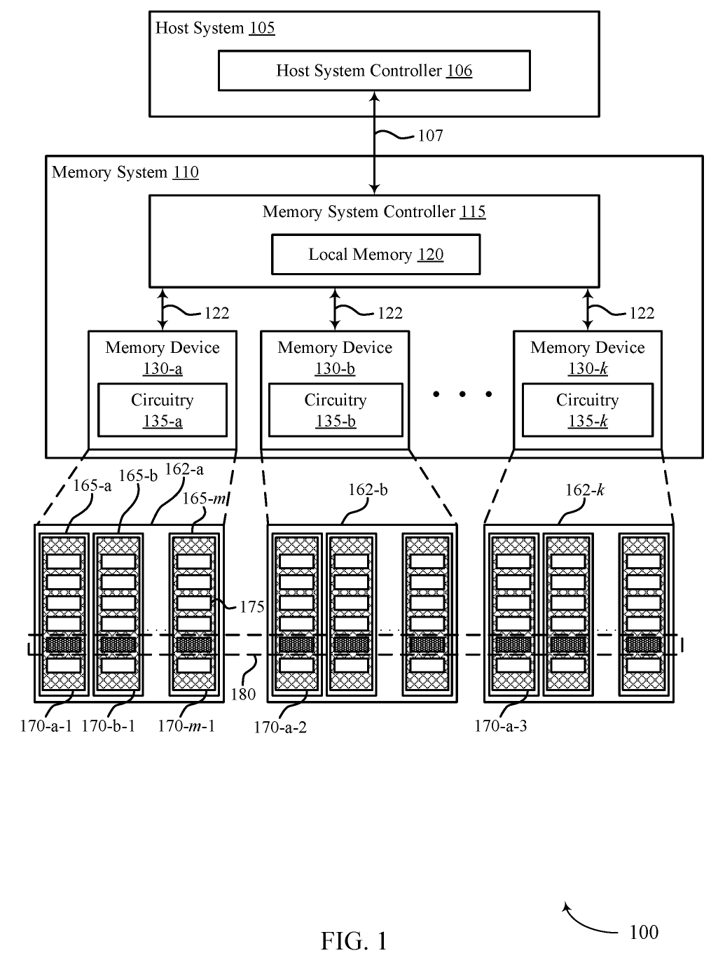

FIG. 1 shows an example of a system 100 that supports techniques for generating compressed address mapping tables in a memory system in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface 107 with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via an interface 107. The host system 105 and the memory system 110 may, in some cases, be configured to communicate via the interface 107 using an associated protocol (e.g., to exchange or otherwise communicate control, address, data, and other signals between the memory system 110 and the host system 105). Examples of the interface 107 may include, but are not limited to, a SATA interface, a UFS interface, an eMMC interface, a PCIe interface, a USB interface, a Fiber Channel interface, a SCSI, a Serial Attached SCSI (SAS) interface, a Double Data Rate (DDR) interface, a DIMM interface (e.g., DIMM socket interface that supports DDR), an Open NAND Flash Interface (ONFI), Mobile Industry Processor Interface (MIPI) Unified Protocol (UniPro), MIPI Physical (M-PHY) interface, and a Low Power Double Data Rate (LPDDR) interface. In some examples, multiple such interfaces 107 may be included in or otherwise supported between a host system controller 106 of the host system 105 and a memory system controller 115 of the memory system 110 (e.g., the interface 107 may support communication via multiple protocol layers such as UFS at an application layer, UniPro at a transport layer, and M-PHY at a physical layer).

The memory system 110 may include a memory system controller 115 and one or more memory devices 130. A memory device 130 may include one or more memory arrays of any type of memory cells (e.g., non-volatile memory cells, volatile memory cells, or any combination thereof). The memory system 110 may include memory devices 130-a, 130-b, up to 130-k, where k represents any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the interface 107) and may be an example of a controller or control component configured to cause the memory system 110 to perform various operations in accordance with examples as described herein. The memory system controller 115 may also be coupled with and communicate with memory devices 130 via respective interfaces 122 to perform operations such as reading data, writing data, erasing data, or refreshing data at a memory device 130—among other such operations—which may generically be referred to as access operations. In some examples, the respective interfaces 122 may be examples of single data rate (SDR) interfaces, DRR interfaces, ONFI interfaces, and the like. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include volatile memory (e.g., static random access memory (SRAM), dynamic random access memory (DRAM), or other memory) that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or respective circuitry 135, which may be internal to memory devices 130, respectively, to perform the functions ascribed herein to the memory system controller 115. In general, one or more functions ascribed herein to the memory system controller 115 may, in some cases, be performed instead by the host system 105, circuitry 135, or any combination thereof. For example, the circuitry 135 may be or include a microcontroller, special purpose logic circuitry (e.g., an FPGA, an ASIC, a DSP), or any other suitable processor or processing circuitry. Thus, in some instances, “processor” or “processing circuitry” may refer to functions performed by the memory system controller 115, the host system 105, the circuitry 135 of one or more memory devices 130, or any combination thereof. In some cases, a memory system 110 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as DRAM memory cells or SRAM memory cells.

In some examples, a memory device 130 may include (e.g., on the same die, within the same package) circuitry 135, which may execute or otherwise support operations on one or more memory cells of the respective memory device 130. Respective circuitry 135 may operate in conjunction with a memory system controller 115 or may perform one or more functions ascribed herein to the memory system controller 115. For example, as illustrated in FIG. 1, a memory device 130-a may include circuitry 135-a, a memory device 130-b may include circuitry 135-b, and a memory device 130-k may include circuitry 135-k.

In some cases, a memory device 130 may be or include a NAND device (e.g., NAND flash device). A memory device 130 may be or include a die 162 (e.g., a memory die). For example, in some cases, a memory device 130 may be a package that includes one or more dies 162. A die 162 may, in some examples, be a piece of electronics-grade semiconductor cut from a wafer (e.g., a silicon die cut from a silicon wafer). The memory cells for each die 162 may be arranged in one or more planes 165, and each plane 165 may include one or more blocks 170, where each block 170 may include one or more pages 175, and each page 175 may include a set of memory cells. In some examples, each die 162 may include m planes 165 and each plane may include n blocks 170 (e.g., with the example of FIG. 1 illustrating one block 170 per plane 165), where m and n represent positive integers.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases concurrent operations may be performed on different planes 165 or on different blocks 170. For example, concurrent operations may be performed on memory cells within different blocks 170 so long as the different blocks 170 are in different planes 165. In some examples, each memory die 162 may include any quantity of planes 165. For example, the memory die 162-a may include a plane 165-a, a plane 165-b, and a plane 165-m, where m represents an Mth plane. The memory die 162-b and the memory die 162-k may also include M planes. In some cases, an individual block 170 may be referred to as a physical block, and a virtual block 180 may refer to a group of blocks 170 within which concurrent operations may occur. A virtual block 180 may be a logical structure that includes a plurality of blocks 170, and different blocks 170 of the plurality of blocks 170 may come from different planes 165 or different memory dies 162. In some cases, a virtual block 180 may include blocks 170 from different memory devices 130 (e.g., including blocks in one or more planes 165 of memory device 130-a, memory device 130-b, and memory device 130-k). In some examples, a virtual block 180 may include a respective block 170 from each plane 165 (e.g., a block 170 from each plane 165) of one or more memory dies 162.

In some cases, the blocks 170 within a virtual block 180 may have the same block address within their respective planes 165. For example, block 170-a-1 may be “block 0” of a first plane 165 of die 162-a, block 170-a-2 may be “block 0” of a first plane 165 of die 162-b, block 170-a-3 may be “block 0” of a first plane 165 of die 162-k, and so on. By way of further example, block 170-b-1 may be “block 1” of a first plane 165 of die 162-a and block 170-m-1 may be “block m-1” of die 162-a, where m represents an Mth block. The memory die 162-b and the memory die 162-k may also include M blocks 170. In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). For example, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be restricted from being re-written with new data until they are erased. Thus, for example, an invalid page 175 may, in some cases, not be updated until the entire block 170 that includes the page 175 has been erased.

In some cases, to update some data within a block 170 while retaining other data within the block 170, the memory device 130 may write the updated data to a new block 170. The memory device 130 (e.g., circuitry 135) or the memory system controller 115 may mark or otherwise designate the addresses of the data that was updated in the block 170 as invalid or obsolete and may update a logical-to-physical (L2P) mapping table to associate the logical address (e.g., LBA) for the data with the new block 170 rather than the original block 170. In some cases, such copying and remapping may be performed instead of erasing and rewriting the entire old block 170 due to latency or wearout considerations, for example. In some cases, one or more copies of an L2P mapping table may be stored within the memory cells of the memory device 130 (e.g., within one or more blocks 170 or planes 165) for use (e.g., reference and updating) by circuitry 135 or memory system controller 115.

In some cases, L2P mapping tables may be maintained and data may be marked as valid or invalid at the page level of granularity, and a page 175 may contain valid data, invalid data, or no data. Invalid data may be data that is outdated, which may be due to a more recent or updated version of the data being stored in a different page 175 of the memory device 130. Invalid data may have been previously programmed to the invalid page 175 but may no longer be associated with a valid logical address, such as a logical address referenced by the host system 105. Valid data may be the most recent version of such data being stored on the memory device 130. A page 175 that includes no data may be a page 175 that has never been written to or that has been erased.

In some cases, a memory system controller 115 or circuitry 135 may perform operations (e.g., as part of one or more media management algorithms) for a memory device 130, such as wear leveling, background refresh, garbage collection, scrub, block scans, health monitoring, or others, or any combination thereof. For example, within a memory device 130, a block 170 may have some pages 175 containing valid data and some pages 175 containing invalid data. To avoid waiting for all of the pages 175 in the block 170 to have invalid data in order to erase and reuse the block 170, an algorithm referred to as “garbage collection” may be invoked to allow the block 170 to be erased and released as a free block for subsequent write operations. Garbage collection may refer to a set of media management operations that include, for example, selecting a block 170 that contains valid and invalid data, selecting pages 175 in the block that contain valid data, copying the valid data from the selected pages 175 to new locations (e.g., free pages 175 in another block 170), marking the data in the previously selected pages 175 as invalid, and erasing the selected block 170. As a result, the quantity of blocks 170 that have been erased may be increased such that more blocks 170 are available to store subsequent data (e.g., data subsequently received from the host system 105).

The memory system 110 may use various levels of address mapping tables (also referred to as sets of address mapping information) to perform address translation for logical addresses indicated by the access commands received from the host system 105. For example, the memory system 110 may use one or more higher-level address mapping tables to point to the physical address of a lower-level (e.g., PPT3) address mapping table that indicates the physical addresses mapped to a set of sequential logical addresses. The physical addresses may be associated with physical memory locations of the memory system 110. The memory system 110 may store the address mapping tables in non-volatile memory (e.g., in the memory devices 130) to avoid loss of the address mapping information in the event of a power outage. During operation, the memory system 110 may load the address mapping tables into the local memory 120 so that the memory system controller 115 can perform address translation for logical addresses indicated by an access command.

Thus, execution of access commands involves transferring the address mapping tables from the memory devices 130 to the local memory 120. But the transfer time for an address mapping table may be proportional to the size of the address mapping table, so large (e.g., 4kB) address mapping tables may increase the latency of access operations such as read operations. If a large data set (e.g., a data set associated with an AI application) implicates many address mapping tables, the latency issues with large address mapping tables may be exacerbated.

According to the techniques described herein, the memory system 110 may reduce the latency of access operations (e.g., read operations) by employing a scheduling technique that allows the memory system 110 to write data in a manner that enables address mapping table compression. For example, the memory system 110 may schedule and issue access commands (e.g., write commands) such that data associated with the sequential logical addresses of an address mapping table is written to sequential physical addresses. Such a technique may allow the memory system 110 to reduce the size of the address mapping table by updating the address mapping table to indicate fewer physical addresses (e.g., the physical address for the starting logical address associated with the address mapping table), as opposed to indicating the individual physical addresses associated with each logical address. The compressed address mapping table may also include an indication of the compression so that components of the memory system 110 (e.g., the memory system controller 115) are aware of the compression status of the address mapping table.

The system 100 may include any quantity of non-transitory computer readable media that support techniques for generating compressed address mapping tables in a memory system. For example, the host system 105 (e.g., a host system controller 106), the memory system 110 (e.g., a memory system controller 115), or a memory device 130 (e.g., a circuitry 135), or any combination thereof may include or otherwise may access one or more non-transitory computer readable media storing instructions (e.g., firmware, logic, code) for performing the functions ascribed herein to the host system 105, the memory system 110, or the memory device 130, or combination thereof. For example, such instructions, if executed by the host system 105 (e.g., by a host system controller 106), by the memory system 110 (e.g., by a memory system controller 115), or by a memory device 130 (e.g., by circuitry 135), may cause the host system 105, the memory system 110, or the memory device 130 to perform associated functions as described herein.

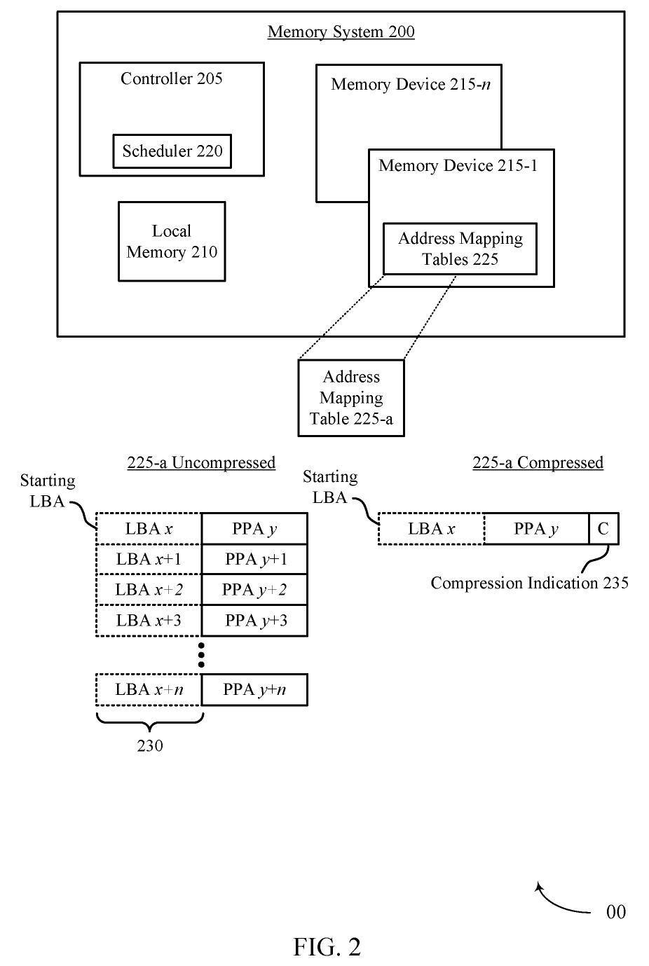

FIG. 2 shows an example of a memory system 200 that supports techniques for generating compressed address mapping tables in accordance with examples as disclosed herein. The memory system 200 may be an example of the memory system 110 as described with reference to FIG. 1. The memory system 200 may include a controller 205, which may be an example of the memory system controller 115 as described with reference to FIG. 1, and a local memory 210, which may be an example of the local memory 120 described with reference to FIG. 1. The memory system 200 may also include memory devices 215 (denoted memory device 215-1 through memory device 215-n), which may be examples of the memory devices 130 described with reference to FIG. 1. The memory system 200 may schedule access commands from a host system so that data is written to the memory devices 215 in a manner that supports address table compression.

The memory system 200 may store address mapping tables, such as the address mapping tables 225, in one or more of the memory devices 215. The address mapping tables 225 may be transferred from the memory devices 215 to the local memory 210 to facilitate address management and address translation for access operations. For example, for a write operation an address mapping table may be transferred to the local memory 210 (a process referred to as “loading”) so that the address mapping table can be updated (e.g., by the controller 205) with the physical addresses mapped to the logical addresses implicated in the write operation. For a read operation, an address mapping table may be transferred to the local memory 210 so that address translation can be performed (e.g., by the controller 205) for the logical address implicated in the read operation. In some examples, the controller 205 may be or include a flash translation layer (FTL).

The address mapping tables 225 may include higher level address mapping tables and lower-level address mapping tables, where higher level address mapping tables point to (e.g., indicate the physical addresses of) lower-level address mapping tables, which in turn indicate logical-to-physical address mappings. For example, a lower-level address mapping table 225-a (e.g., PPT3) may indicate the physical addresses that are mapped to a set of logical addresses 230 associated with the address mapping table 225-a. The set of logical addresses 230 associated with the address mapping table 225-a may be numerically sequential (e.g., increment by one) and may begin from a starting logical address (e.g., the numerically first logical address associated with the address mapping table 225-a).

As an illustration, the address mapping table 225-a may be associated with starting logical address LBA x, which is included the set of logical addresses 230 that are sequential (e.g., consecutive, contiguous, sequentially indexed). The set of logical addresses 230 may include n+1 (e.g., 1k) logical addresses, each of which may be associated with an amount of data (e.g., 4k) so that the address mapping table 225-a contains mapping information for a threshold amount of data (e.g., 4MB).

The address mapping table 225-a may include the logical addresses mapped to the set of logical addresses 230. For example, the address mapping table 225-a may include physical address PPA y, which may be mapped to (e.g., correspond to, be associated with) logical address LBA x. And so on and so forth as illustrated in FIG. 2. Each physical address may be represented by a quantity of bits (e.g., 4B). So, without compression, the address mapping table 225-a may have a first size (e.g., 4kB). But the first size of the address mapping table 225-a may be associated with a long loading latency (e.g., for transferring the address mapping table 225-a into the local memory 210).

According to the techniques described herein, the memory system 200 may write (in the memory devices 215) the data associated with the set of logical addresses 230 so that the physical addresses mapped to the set of logical addresses 230 are numerically sequential (e.g., increment by one). Such a technique may allow the address mapping table 225-a to be compressed into having a second size (e.g., 4B). For example, the address mapping table 225-a may be updated to include the physical address mapped to the starting logical address (e.g., LBA x) of the set of logical addresses 230, and to include an indication of the compression (e.g., compression indication 235, denoted “C”). The compression indication 235 may allow the controller 205 to determine that the physical addresses for the set of logical addresses 230 are sequential. Accordingly, the controller 205 may determine the mapping for each logical address using offsets from the starting logical address x. For example, for a logical address x+3, the controller 205 may determine that the physical address is equal to the physical address for the starting logical address plus three.

Thus, the techniques described herein may enable generation of compressed address mapping tables, where generating a compressed address mapping table may refer to updating the address mapping table or creating the address mapping table.

Unlike the uncompressed address mapping table 225-a, the compressed address mapping table 225-a may exclude the physical addresses mapped to the other logical addresses in the set of logical addresses 230. For example, if the compression indication 235 is one bit and PPA y is represented by thirty-one bits, the compressed address mapping table 225-a may have a size equal to 4B. Thus, the compressed address mapping table 225-a may have a smaller size than the uncompressed address mapping table 225-a while still conveying the same address mapping information.

Compression of an address mapping table 225 may be conditioned on the physical addresses of the address mapping table 225 (e.g., the physical addresses mapped to the set of logical addresses associated with that address mapping table 225) being sequential. But scheduling and issuing access commands in the order that the access commands are received from the host system may not result in the physical addresses of an address mapping table 225 being sequential.

According to the techniques described herein, the memory system 200 may (e.g., via the controller 205) re-order access commands so that the associated data is stored in memory locations that have sequential physical addresses. For example, the controller 205 may group write commands associated with the logical addresses of an address mapping table 225 into a first group (or first “thread”) and may group other write commands into a second group (or second “thread”). The scheduler 220 may issue the write commands from the first group until a condition is met. For example, the scheduler 220 may issue write commands from the first group until the data written to the memory devices 215 is equal to the threshold amount of data (e.g., 4MB) associated with the address mapping table 225, which may be indicated by the scheduler 220 reaching a write command for the starting logical address of a different address mapping table. Before issuing that write command, the scheduler 220 may switch to issuing the write commands from the second group. Such scheduling of access commands may ensure that the data associated with the logical addresses of an address mapping table 225 is written to sequential physical addresses, thereby enabling compression of the address mapping table 225.

Thus, the memory system 200 may write data to the memory devices 215 in a manner that supports address table compression, which may improve the latency of the memory system 200. Although described with reference to address mapping tables that are associated with a threshold amount of data (e.g., 4MB), the address mapping tables may be associated with other threshold amounts of data (e.g., 8MB, 16MB).

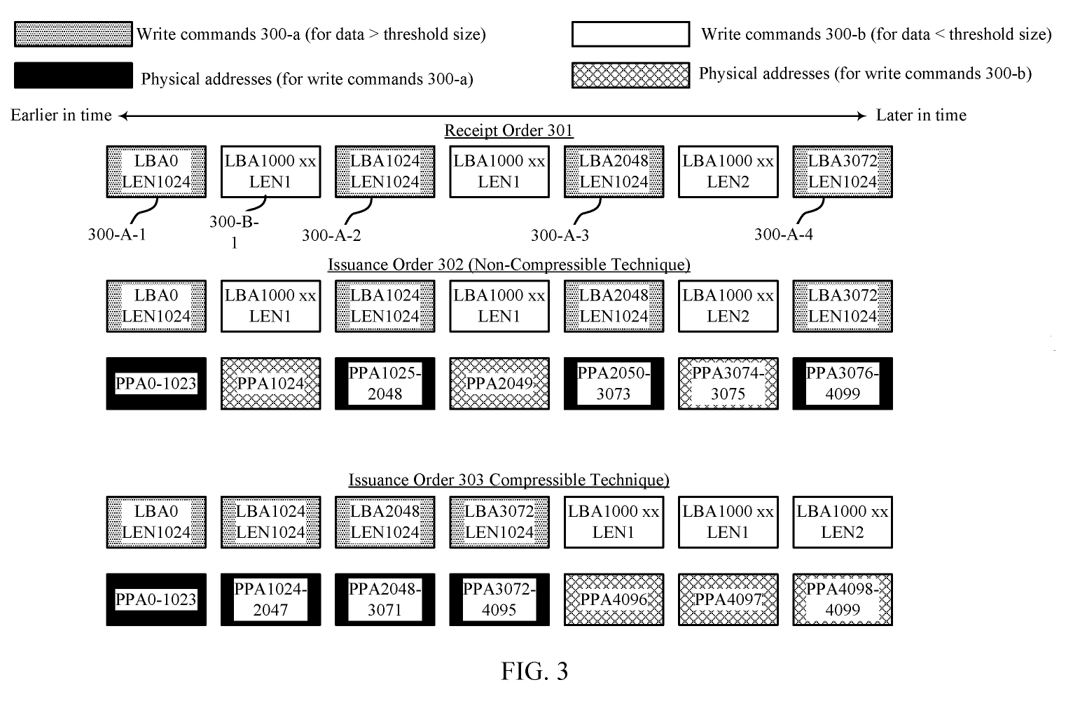

FIG. 3 shows an example of write commands 300 that support techniques for generating compressed address mapping tables in a memory system in accordance with examples as disclosed herein. The write commands 300 may include write commands 300-a for amounts of data greater than a threshold size and write commands 300-b for amounts of data less than the threshold size. Each write command may indicate a beginning logical address and an amount of data (e.g., LEN1024, LEN1, LEN2) associated with the write command. In some examples, LEN1024 may be equal to 4MB, LEN1 may be equal to 4k, LEN2 may be equal to 8k. For scheduling and issuance, a memory system may re-order the write commands 300 (e.g., relative to the order of receipt) so that the data associated with the write commands 300 is written to sequential physical addresses, thereby enabling compression of an address mapping table (e.g., an address mapping table associated with a threshold amount of data equal to 16MB).

The write commands 300 may be received from the host system in receipt order 301. For example, write command 300-a-1 may be received from the host system before write command 300-b-1, which may be received write command 300-a-2, and so on and so forth as illustrated in FIG. 3. Adjacent access commands may represent access commands that are received back-to-back (e.g., without any intervening access commands).

As illustrated, the logical addresses for each write command 300-a may be sequential. Further, the subsets of logical addresses for the write commands 300-a may be sequential relative to each other and together may be referred to as a set of sequential logical addresses (e.g., logical address LBA 0 through logical address LBA 4095). For example, the beginning logical address LBA1024 of write command 300-a-2 may be sequential to the last logical address (e.g., LBA1023) of write command 300-a-1. Similarly, the beginning logical address LBA2048 of write command 300-a-3 may be sequential to the last logical address (e.g., LBA2047) of write command 300-a-2. And the beginning logical address LBA3072 of write command 300-a-4 may be sequential to the last logical address (e.g., LBA3071) of write command 300-a-3.

As illustrated by receipt order 301, the write commands 300-a may be interspersed with write commands 300-b, which may be associated with different random logical addresses (denoted LBA1000 xx). If the write commands 300 are issued by the memory system in same order as receipt, as illustrated by issuance order 302, the physical addresses mapped to the set of sequential logical addresses (associated with the write commands 300-a) may not be sequential. For example, physical address PPA 1024, which is sequential with A) the last physical address mapped to write command 300-a-1 and B) the beginning physical address mapped to write command 300-a-2, may be mapped to the logical address associated with write command 300-b-1. So the set of sequential logical addresses associated with the write commands 300-a may be mapped to a set of non-sequential physical addresses, which may prevent compression of the address mapping table associated with the set of sequential logical addresses (e.g., LBA 0 through LBA 4095).

According to the techniques described herein, the memory system may re-order the write commands 300 so that the write commands 300 are issued as illustrated by issuance order 303, which may enable compression of the address mapping table. For example, the memory system may group the write commands 300-a into a first group, group the write commands 300-b into a second group, and issue the write commands 300-a in the first group before issuing the write commands 300-b in the second group. Such a technique may ensure that the physical addresses mapped to the set of sequential logical addresses (associated with the write commands 300-a) are sequential. For example, the set of sequential logical address associated with the write commands 300-a (e.g., LBA 0 through LBA 4095) may be mapped to a set of sequential physical addresses (e.g., PPA 0 through PPA 4095).

The memory system may select a write command for inclusion in the first group in accordance with (e.g., based on, due to) the size of the data associated with the write command, in accordance with (e.g., based on, due to) the logical addresses associated with the write command, or both. For example, the memory system may select write command 300-a-1 for the first group in accordance with the beginning logical address associated with write command 300-a-1 being sequential to the last logical address of an earlier-received write command, in accordance with the amount of data associated with write commands 300-a-1 being greater than the threshold size, or both. The memory system may select write command 300-a-2 for the first group in accordance with the beginning logical address associated with write command 300-a-2 being sequential to the last logical address associated with write command 300-a-1, in accordance with the amount of data associated with write commands 300-a-2 being greater than the threshold size, or both. And so on and so forth.

In some examples, the memory system may re-order the write commands 300 in accordance with (e.g., based on) a write mode of the memory system. For example, the memory system may re-order the write commands 300 in accordance with the memory system being in a sequential write mode in which the memory system writes data to physical locations with sequential physical addresses.

Thus, the memory system may re-order access commands (e.g., relative to the order of receipt) so that the data associated with the access commands is written to sequential physical addresses, thereby enabling compression of an address mapping table.

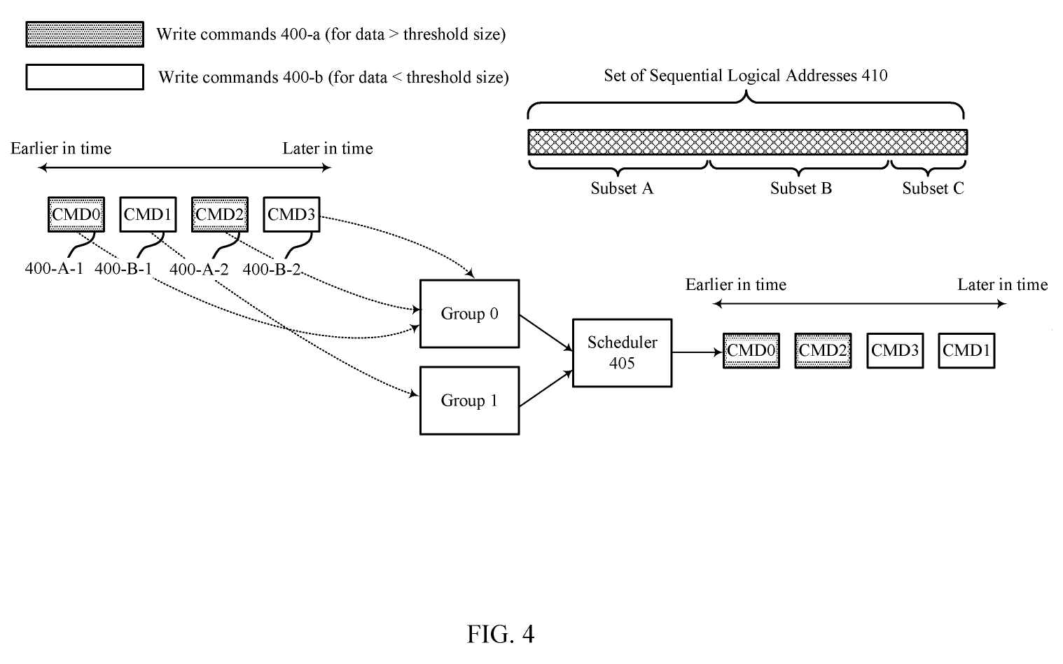

FIG. 4 shows an example of a scheduler 405 that supports techniques for generating compressed address mapping tables in a memory system in accordance with examples as disclosed herein. The scheduler 405 may be an example of a scheduler 220 as described with reference to FIG. 2. For example, the scheduler 405 may be included in, or be coupled with, a controller such as the controller 205 or the memory system controller 115 as described herein. The controller may organize received access commands into groups so that the scheduler 220 can issue the access commands in a different order than they were received. Such re-ordering may allow data associated with the access commands to be written to sequential physical addresses, which in turn permits compression of the address mapping table associated with the logical addresses for the data.

The commands issued by the scheduler 405 may include write commands 400-a (e.g., CMD0, CMD2) for amounts of data greater than a threshold size and write commands 400-b (e.g., CMDCMD3) for amounts of data less than the threshold size. The write commands CMD0, CMD2, and CMD3 may be associated with a set of sequential logical addresses 410. For example, write command CMD0 may be associated with subset A of the set of sequential logical addresses 410, write command CMD2 may be associated with subset B of the set of sequential logical addresses 410, and write command CMD3 may be associated with subset C of the set of sequential logical addresses 410. Thus, the numerically first logical address of subset B (associated with write command CMD2) may be sequential to the numerically last logical address of subset A (associated with write command CMD0), and the numerically first logical address of subset C (associated with write command CMD3) may be sequential to the numerically last logical address of subset B. The write command CMD1 may be a random write command (e.g., a write command whose associated logical addresses are not sequential relative to the other write commands).

The controller may group the write commands 400 in accordance with (e.g., based on) the amount of data associated with the write commands 400, in accordance with (e.g., based on) the logical addresses of the write commands 400, or both. For example, the controller may group the write commands CMD0 and CMD2 into Group 0 (also referred to as “Thread 0”) in accordance with the write commands CMD0 and CMD2 being for amounts of data greater than the threshold size, and being associated with the set of sequential logical addresses 410. Although write command CMD3 is for an amount of data less than the threshold size, the controller may select write command CMD3 for inclusion in Group 0 because write command CMD3 is associated with the set of sequential logical addresses 410. That is, the write command CMD3 may be added to Group 0 because the numerically first logical address of the write command CMD3 is sequential to the numerically last logical address of the write command CMD2. The controller may add write command CMD1 to Group 1 because the write command CMD1 is for an amount of data less than the threshold size and is not associated with the set of sequential logical addresses.

The scheduler 405 may issue write commands from Group 0 until a threshold amount of data (e.g., equal to the threshold amount of data associated with the corresponding address mapping table) has been written to the memory system (e.g., to a set of sequential physical addresses). For example, the scheduler 405 may issue write commands from Group 0 until a write command is reached whose beginning logical address matches the starting logical address of another address mapping table, at which point the scheduler 405 may switch (before issuing that write command) to issuing write commands from Group 1. In some examples, the starting logical address of the next address mapping table may be an integer multiple of the threshold amount of data (e.g., 4MB) associated with the address mapping tables.

While the memory system is busy issuing write commands from Group 0 and writing associated data, the memory system may store the data associated with Group 1 in a local memory. Such storage may be possible because the sizes of the data associated with Group 1 are less than the threshold size, thus enabling accumulation in the local memory without overwhelming the capacity of the local memory. After writing the threshold amount of data from Group 0 in the memory system, the scheduler 405 may then issue the write commands from Group 2 until the local memory is cleared out. So, as illustrated, the scheduler 405 may issue write commands CMD0, CMD2, and CMD3 before issuing write command CMD1.

Filtering the write commands in accordance with the corresponding amount of data may prevent the local memory from being overwhelmed. In an alternative example where write command CMD0 (or CMD2) is for an amount of data greater than the threshold size but not associated with the set of sequential logical addresses, the controller may still add this write command to Group 0 to avoid overwhelming the capacity of the local memory. However, in such a scenario, the associated address mapping table may not be compressible due to the resulting discontinuity of the corresponding physical addresses.

Thus, received write commands may be organized into groups so that the scheduler 220 can issue the access commands in a different order than they were received, which may permit compression of the address mapping table associated with the logical addresses for the data.

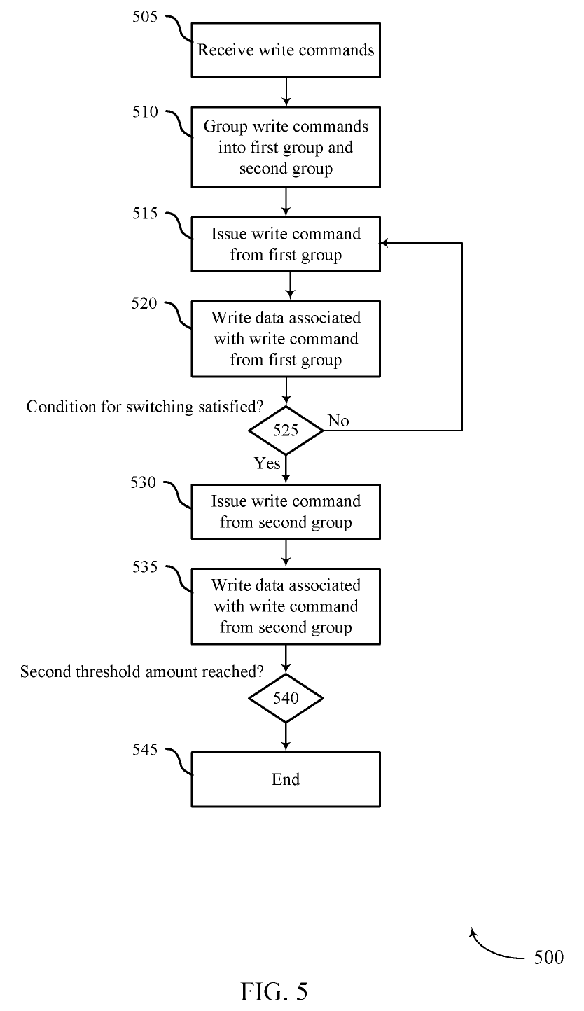

FIG. 5 shows an example of a process flow 500 that supports techniques for generating compressed address mapping tables in a memory system in accordance with examples as disclosed herein. The process flow 500 may be implemented by a memory system such as the memory system 110 or the memory system 200. The memory system may implement the process flow 500 to enable the generation of compresses address mapping tables, which in turn may reduce the latency of the memory system.

Aspects of the process flow 500 may be implemented by one or more controllers, among other components. Additionally or alternatively, aspects of the process flow 500 may be implemented as instructions stored in one or more memories (e.g., firmware stored in one or more memories coupled with the memory system 200). For example, the instructions, when executed by one or more controllers (e.g., the controller 205), may cause the one or more controllers (or a device or a system) to perform the operations of the process flow 500.

At 505, write commands may be received. At 510, the write commands may be grouped into a first group (e.g., Group 0) and a second group (e.g., Group 1). The write commands may be grouped into the groups if the memory system is in a sequential write mode. A write command may be included in the first group if the write command is for a set of data having at least a threshold size and if the write command has a numerically first logical address that is sequential to a numerically last logical address of another write command in the first group. A write command may be included in the second group if the write command is for a set of data having less than the threshold size, if the write command does not have a numerically first logical address that is sequential to a numerically last logical address of another write command in the first group, or both.

At 515, a write command from the first group may be issued (e.g., from a scheduler to a memory device). At 520, data associated with the write command may be written to the memory device. At 525, it may be determined whether a condition for switching from the first group to the second group is satisfied. For example, the memory system may determine whether a first threshold amount of data associated with the first group has been written. Additionally or alternatively, the memory system may determine whether the next write command for issuance from the first group is associated with a logical address that matches the starting logical address of another address mapping table. For example, the memory system may determine whether the next write command for issuance from the first group is associated with a logical address that is an integer of 4MB (e.g., the threshold amount of data associated with the address mapping tables).

If the condition for switching is not satisfied, the memory system may return to 515 and issue another write command from the first group. If the condition for switching is satisfied, the memory system may proceed to 530. The first threshold amount may be equal to the threshold amount of data associated with an address mapping table that is associated with the set of sequential logical addresses associated with the write commands in the first group.

At 530, a write command from the second group may be issued (e.g., from a scheduler to a memory device). At 535, data associated with the write command may be written to the memory device. At 540, it may be determined whether a second threshold amount of data associated with the second group has been written. If no, the memory system may return to 5530 and issue another write command from the second group. If yes, the memory system may proceed to 545 and end the process. The second threshold amount may be equal to the amount of data associated with the second group that is stored in a local memory, or the second threshold may be a fixed amount configured by the memory system.

Thus, the process flow 500 may be implemented to enable the generation of compresses address mapping tables, which in turn may reduce the latency of the memory system.

Although shown in a serial manner, operations of the process flow 500 may be performed concurrently (e.g., during partially or wholly overlapping times). Further, various operations may be rearranged, repeated, omitted, or added, to implement the techniques described herein.

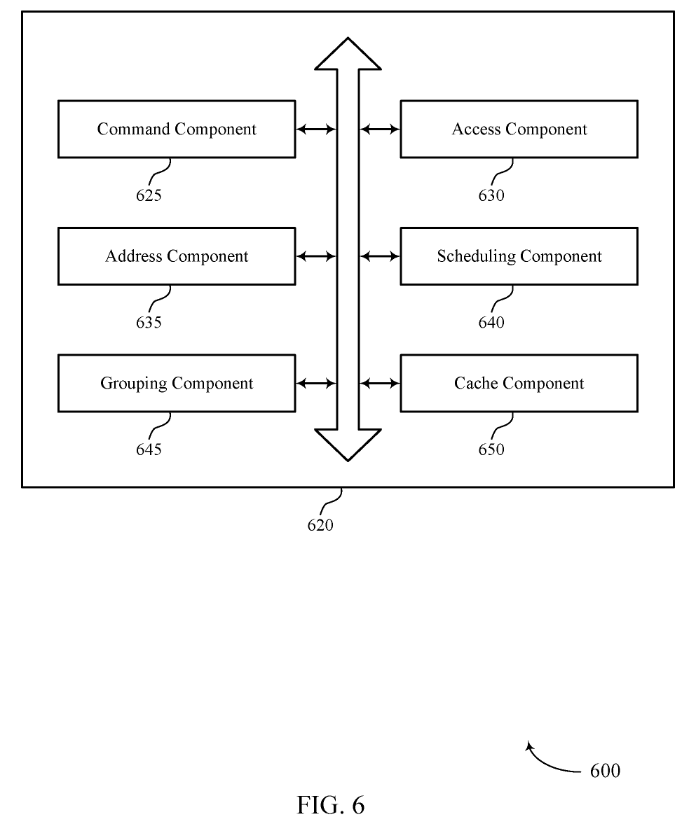

FIG. 6 shows a block diagram 600 of a memory system 620 that supports techniques for generating compressed address mapping tables in a memory system in accordance with examples as disclosed herein. The memory system 620 may be an example of aspects of a memory system as described with reference to FIGS. 1-5. The memory system 620, or various components thereof, may be an example of means for performing (e.g., to cause the memory system 620 to perform) various aspects of techniques for generating compressed address mapping tables in a memory system as described herein. For example, the memory system 620 may include a command component 625, an access component 630, an address component 635, a scheduling component 640, a grouping component 645, a cache component 650, or any combination thereof. Each of these components, or components of subcomponents thereof (e.g., one or more processors, one or more memories), may communicate, directly or indirectly, with one another (e.g., via one or more buses).

The command component 625 may be configured as or otherwise support a means for receiving a first set of commands and a second set of commands that are interspersed with the first set of commands, the first set of commands associated with a set of sequential logical addresses. The access component 630 may be configured as or otherwise support a means for writing, in accordance with the first set of commands being associated with the set of sequential logical addresses, a threshold amount of first data associated with the first set of commands to a set of sequential physical addresses in a memory system. In some examples, the access component 630 may be configured as or otherwise support a means for writing second data associated with the second set of commands in response to writing the threshold amount of first data. The address component 635 may be configured as or otherwise support a means for generating, in response to writing the threshold amount of first data to the set of sequential physical addresses, a compressed version of an address mapping table associated with the set of sequential logical addresses associated with the first set of commands.

In some examples, generating the compressed version of the address mapping table includes reducing a size of the address mapping table.

In some examples, the grouping component 645 may be configured as or otherwise support a means for grouping the first set of commands into a first group. In some examples, the grouping component 645 may be configured as or otherwise support a means for grouping the second set of commands into a second group, where the first set of commands are issued before the second set of commands.

In some examples, the first set of commands is grouped into the first group in accordance with the first set of commands being associated with the set of sequential logical addresses.

In some examples, the first set of commands is grouped into the first group in accordance with the first set of commands each being associated with a threshold data size.

In some examples, the cache component 650 may be configured as or otherwise support a means for storing, until the threshold amount of first data is written to the set of sequential physical addresses, the second data in a local memory in accordance with the second set of commands being grouped into the second group.

In some examples, the address component 635 may be configured as or otherwise support a means for determining whether a command of the first set of commands is associated with a starting logical address of a second address mapping table. In some examples, the access component 630 may be configured as or otherwise support a means for switching, before writing data associated with the command, from writing the first data to writing the second data in accordance with the command being associated with the starting logical address of the second address mapping table.

In some examples, the compressed version of the address mapping table includes an indication that the address mapping table is compressed, includes a physical address for a numerically first logical address associated with the address mapping table, and excludes physical addresses for a remainder of logical addresses associated with the address mapping table.

In some examples, the address mapping table is associated with an amount of data. In some examples, the threshold amount of first data is equal to the amount of data associated with the address mapping table.

In some examples, a first command of the first set of commands is received before a second command of the second set of commands. In some examples, data associated with the first command is written before data associated with the second command is written.

In some examples, the access component 630 may be configured as or otherwise support a means for writing, to the memory system, additional first data associated with the first set of commands in response to writing the second data.

In some examples, the command component 625 may be configured as or otherwise support a means for receiving a first set of commands and a second set of commands that are interspersed with the first set of commands, the first set of commands associated with a set of sequential logical addresses. The scheduling component 640 may be configured as or otherwise support a means for issuing the first set of commands to a memory device before the second set of commands in accordance with the first set of commands being associated with the set of sequential logical addresses. In some examples, the access component 630 may be configured as or otherwise support a means for writing, in response to issuing the first set of commands, a threshold amount of first data associated with the first set of commands to a set of sequential physical addresses in the memory device. In some examples, the access component 630 may be configured as or otherwise support a means for writing second data associated with the second set of commands in response to issuing the second set of commands. In some examples, the address component 635 may be configured as or otherwise support a means for generating, in response to writing the threshold amount of first data to the set of sequential physical addresses, a compressed version of an address mapping table associated with the set of sequential logical addresses associated with the first set of commands.

In some examples, the grouping component 645 may be configured as or otherwise support a means for grouping the first set of commands into a first group, where the first set of commands are issued in accordance with being included in the first group. In some examples, the grouping component 645 may be configured as or otherwise support a means for grouping the second set of commands into a second group, where the second set of commands is issued in accordance with being included in the second group.

In some examples, the first set of commands is grouped into the first group in accordance with the first set of commands being associated with the set of sequential logical addresses.

In some examples, the first set of commands is grouped into the first group in accordance with the first set of commands each being associated with a threshold data size.

In some examples, the cache component 650 may be configured as or otherwise support a means for storing, until the threshold amount of first data is written to the set of sequential physical addresses, the second data in a local memory in accordance with the second set of commands being grouped into the second group.

In some examples, the compressed version of the address mapping table includes an indication that the address mapping table is compressed, and includes a physical address for a numerically first logical address associated with the address mapping table.

In some examples, the address mapping table is associated with an amount of data. In some examples, the threshold amount of first data is equal to the amount of data associated with the address mapping table.

In some examples, a first command of the first set of commands is received before a second command of the second set of commands. In some examples, the first command is issued before the second command is issued.

In some examples, the access component 630 may be configured as or otherwise support a means for writing, to the memory device, additional first data associated with the first set of commands in response to writing the second data.

In some examples, the described functionality of the memory system 620, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements) that are configured to cause the memory system 620 to perform one or more operations. In some examples, the described functionality of the memory system 620, or various components thereof, may be implemented at least in part by instructions (e.g., stored in memory, non-transitory computer-readable medium) executable by such at least one processor to cause the memory system 620 to perform one or more operations.

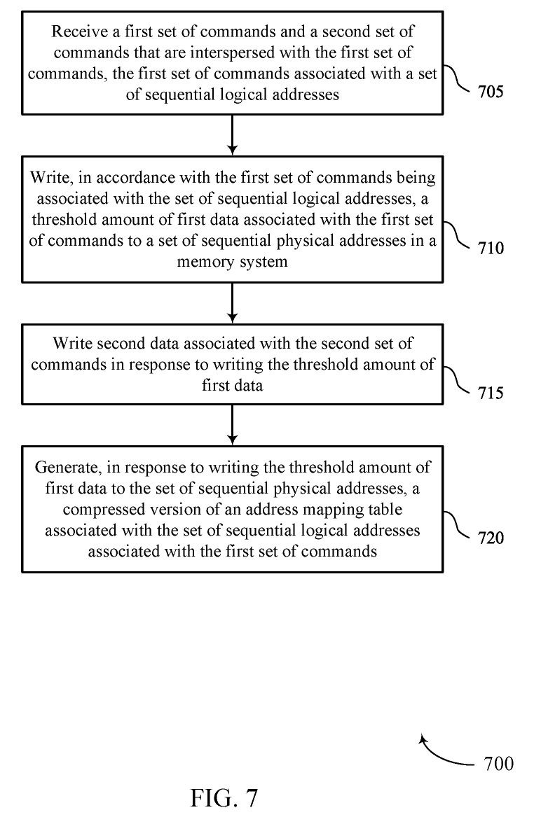

FIG. 7 shows a flowchart illustrating a method 700 that supports techniques for generating compressed address mapping tables in a memory system in accordance with examples as disclosed herein. The operations of method 700 may be implemented by a memory system or its components as described herein. For example, the operations of method 700 may be performed by a memory system as described with reference to FIGS. 1-6. In some examples, a memory system may execute a set of instructions to control the functional elements of the device to perform the described functions. Additionally, or alternatively, the memory system may perform aspects of the described functions using special-purpose hardware.

At 705, the method may include receiving a first set of commands and a second set of commands that are interspersed with the first set of commands, the first set of commands associated with a set of sequential logical addresses. In some examples, aspects of the operations of 705 may be performed by a command component 625.

At 710, the method may include writing, in accordance with the first set of commands being associated with the set of sequential logical addresses, a threshold amount of first data associated with the first set of commands to a set of sequential physical addresses in a memory system. In some examples, aspects of the operations of 710 may be performed by an access component 630.

At 715, the method may include writing second data associated with the second set of commands in response to writing the threshold amount of first data. In some examples, aspects of the operations of 715 may be performed by an access component 630.

At 720, the method may include generating, in response to writing the threshold amount of first data to the set of sequential physical addresses, a compressed version of an address mapping table associated with the set of sequential logical addresses associated with the first set of commands. In some examples, aspects of the operations of 720 may be performed by an address component 635.

In some examples, an apparatus as described herein may perform a method or methods, such as the method 700. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for receiving a first set of commands and a second set of commands that are interspersed with the first set of commands, the first set of commands associated with a set of sequential logical addresses; writing, in accordance with the first set of commands being associated with the set of sequential logical addresses, a threshold amount of first data associated with the first set of commands to a set of sequential physical addresses in a memory system; writing second data associated with the second set of commands in response to writing the threshold amount of first data; and generating, in response to writing the threshold amount of first data to the set of sequential physical addresses, a compressed version of an address mapping table associated with the set of sequential logical addresses associated with the first set of commands.

Aspect 2: The method, apparatus, or non-transitory computer-readable medium of aspect 1, where generating the compressed version of the address mapping table includes reducing a size of the address mapping table.

Aspect 3: The method, apparatus, or non-transitory computer-readable medium of any of aspects 1 through 2, further including operations, features, circuitry, logic, means, or instructions, or any combination thereof for grouping the first set of commands into a first group and grouping the second set of commands into a second group, where the first set of commands are issued before the second set of commands.

Aspect 4: The method, apparatus, or non-transitory computer-readable medium of aspect 3, where the first set of commands is grouped into the first group in accordance with the first set of commands being associated with the set of sequential logical addresses.

Aspect 5: The method, apparatus, or non-transitory computer-readable medium of any of aspects 3 through 4, where the first set of commands is grouped into the first group in accordance with the first set of commands each being associated with a threshold data size.

Aspect 6: The method, apparatus, or non-transitory computer-readable medium of any of aspects 3 through 5, further including operations, features, circuitry, logic, means, or instructions, or any combination thereof for storing, until the threshold amount of first data is written to the set of sequential physical addresses, the second data in a local memory in accordance with the second set of commands being grouped into the second group.

Aspect 7: The method, apparatus, or non-transitory computer-readable medium of any of aspects 1 through 6, further including operations, features, circuitry, logic, means, or instructions, or any combination thereof for determining whether a command of the first set of commands is associated with a starting logical address of a second address mapping table and switching, before writing data associated with the command, from writing the first data to writing the second data in accordance with the command being associated with the starting logical address of the second address mapping table.

Aspect 8: The method, apparatus, or non-transitory computer-readable medium of any of aspects 1 through 7, where the compressed version of the address mapping table includes an indication that the address mapping table is compressed, includes a physical address for a numerically first logical address associated with the address mapping table, and excludes physical addresses for a remainder of logical addresses associated with the address mapping table.

Aspect 9: The method, apparatus, or non-transitory computer-readable medium of any of aspects 1 through 8, where the address mapping table is associated with an amount of data and the threshold amount of first data is equal to the amount of data associated with the address mapping table.

Aspect 10: The method, apparatus, or non-transitory computer-readable medium of any of aspects 1 through 9, where a first command of the first set of commands is received before a second command of the second set of commands and data associated with the first command is written before data associated with the second command is written.

Aspect 11: The method, apparatus, or non-transitory computer-readable medium of any of aspects 1 through 10, further including operations, features, circuitry, logic, means, or instructions, or any combination thereof for writing, to the memory system, additional first data associated with the first set of commands in response to writing the second data.

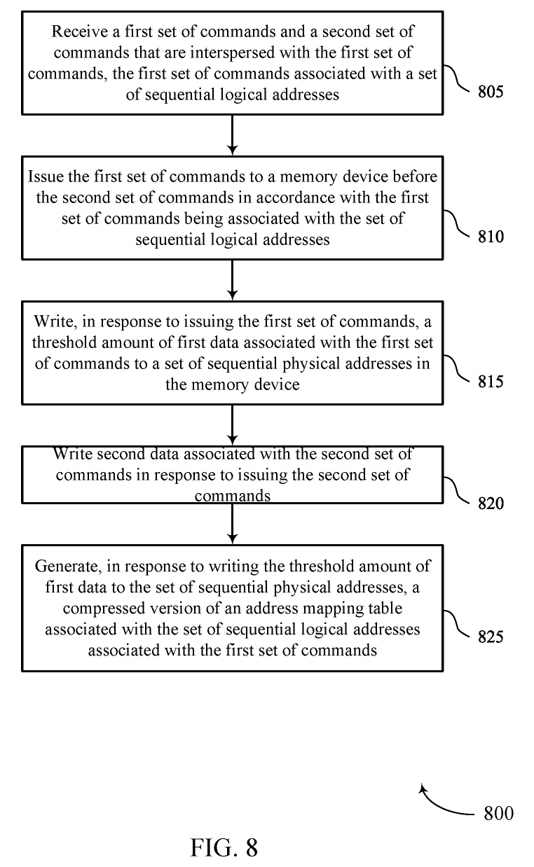

FIG. 8 shows a flowchart illustrating a method 800 that supports techniques for generating compressed address mapping tables in a memory system in accordance with examples as disclosed herein. The operations of method 800 may be implemented by a memory system or its components as described herein. For example, the operations of method 800 may be performed by a memory system as described with reference to FIGS. 1-6. In some examples, a memory system may execute a set of instructions to control the functional elements of the device to perform the described functions. Additionally, or alternatively, the memory system may perform aspects of the described functions using special-purpose hardware.

At 805, the method may include receiving a first set of commands and a second set of commands that are interspersed with the first set of commands, the first set of commands associated with a set of sequential logical addresses. In some examples, aspects of the operations of 805 may be performed by a command component 625.

At 810, the method may include issuing the first set of commands to a memory device before the second set of commands in accordance with the first set of commands being associated with the set of sequential logical addresses. In some examples, aspects of the operations of 810 may be performed by a scheduling component 640.

At 815, the method may include writing, in response to issuing the first set of commands, a threshold amount of first data associated with the first set of commands to a set of sequential physical addresses in the memory device. In some examples, aspects of the operations of 815 may be performed by an access component 630.

At 820, the method may include writing second data associated with the second set of commands in response to issuing the second set of commands. In some examples, aspects of the operations of 820 may be performed by an access component 630.

At 825, the method may include generating, in response to writing the threshold amount of first data to the set of sequential physical addresses, a compressed version of an address mapping table associated with the set of sequential logical addresses associated with the first set of commands. In some examples, aspects of the operations of 825 may be performed by an address component 635.

In some examples, an apparatus as described herein may perform a method or methods, such as the method 800. The apparatus may include features, circuitry, logic, means, or instructions (e.g., a non-transitory computer-readable medium storing instructions executable by a processor), or any combination thereof for performing the following aspects of the present disclosure:

Aspect 12: A method, apparatus, or non-transitory computer-readable medium including operations, features, circuitry, logic, means, or instructions, or any combination thereof for receiving a first set of commands and a second set of commands that are interspersed with the first set of commands, the first set of commands associated with a set of sequential logical addresses; issuing the first set of commands to a memory device before the second set of commands in accordance with the first set of commands being associated with the set of sequential logical addresses; writing, in response to issuing the first set of commands, a threshold amount of first data associated with the first set of commands to a set of sequential physical addresses in the memory device; writing second data associated with the second set of commands in response to issuing the second set of commands; and generating, in response to writing the threshold amount of first data to the set of sequential physical addresses, a compressed version of an address mapping table associated with the set of sequential logical addresses associated with the first set of commands.

Aspect 13: The method, apparatus, or non-transitory computer-readable medium of aspect 12, further including operations, features, circuitry, logic, means, or instructions, or any combination thereof for grouping the first set of commands into a first group, where the first set of commands are issued in accordance with being included in the first group and grouping the second set of commands into a second group, where the second set of commands is issued in accordance with being included in the second group.

Aspect 14: The method, apparatus, or non-transitory computer-readable medium of aspect 13, where the first set of commands is grouped into the first group in accordance with the first set of commands being associated with the set of sequential logical addresses.

Aspect 15: The method, apparatus, or non-transitory computer-readable medium of any of aspects 13 through 14, where the first set of commands is grouped into the first group in accordance with the first set of commands each being associated with a threshold data size.

Aspect 16: The method, apparatus, or non-transitory computer-readable medium of any of aspects 13 through 15, further including operations, features, circuitry, logic, means, or instructions, or any combination thereof for storing, until the threshold amount of first data is written to the set of sequential physical addresses, the second data in a local memory in accordance with the second set of commands being grouped into the second group.

Aspect 17: The method, apparatus, or non-transitory computer-readable medium of any of aspects 12 through 16, where the compressed version of the address mapping table includes an indication that the address mapping table is compressed, and includes a physical address for a numerically first logical address associated with the address mapping table.

Aspect 18: The method, apparatus, or non-transitory computer-readable medium of any of aspects 12 through 17, where the address mapping table is associated with an amount of data and the threshold amount of first data is equal to the amount of data associated with the address mapping table.

Aspect 19: The method, apparatus, or non-transitory computer-readable medium of any of aspects 12 through 18, where a first command of the first set of commands is received before a second command of the second set of commands and the first command is issued before the second command is issued.

Aspect 20: The method, apparatus, or non-transitory computer-readable medium of any of aspects 12 through 19, further including operations, features, circuitry, logic, means, or instructions, or any combination thereof for writing, to the memory device, additional first data associated with the first set of commands in response to writing the second data.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and a second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed, and a second condition or action may occur directly as a result of the previous condition or action occurring independent of whether other conditions or actions occur. In some examples, a first condition or action may be performed, and a second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOS), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor’s threshold voltage is applied to the transistor gate. The transistor may be “off” or “deactivated” if a voltage less than the transistor’s threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, instructions (e.g., code, software, firmware, logic) executed by a processing system (e.g., one or more processors, one or more controllers, control circuitry, processing circuitry, logic circuitry), or any combination thereof that is configured to cause a respective apparatus, device, or system to perform the described functions. If implemented as instructions executed by a processing system, the functions may be stored on or transmitted over as one or more instructions on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof, that are configured to cause the performance of the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more non-volatile memory devices; and
processing circuitry coupled with the one or more non-volatile memory devices and configured to cause the memory system to:
receive a first set of commands and a second set of commands that are interspersed with the first set of commands, the first set of commands associated with a set of sequential logical addresses;
write, in accordance with the first set of commands being associated with the set of sequential logical addresses, a threshold amount of first data associated with the first set of commands to a set of sequential physical addresses in a memory system;
write second data associated with the second set of commands in response to writing the threshold amount of first data; and
generate, in response to writing the threshold amount of first data to the set of sequential physical addresses, a compressed version of an address mapping table associated with the set of sequential logical addresses associated with the first set of commands.

2. The memory system of claim 1, wherein generating the compressed version of the address mapping table comprises reducing a size of the address mapping table.

3. The memory system of claim 1, wherein the processing circuitry is further configured to cause the memory system to:
group the first set of commands into a first group; and
group the second set of commands into a second group, wherein the first set of commands are issued before the second set of commands.

4. The memory system of claim 3, wherein the first set of commands is grouped into the first group in accordance with the first set of commands being associated with the set of sequential logical addresses.

5. The memory system of claim 1, wherein the processing circuitry is further configured to cause the memory system to:
determine whether a command of the first set of commands is associated with a starting logical address of a second address mapping table; and
switch, before writing data associated with the command, from writing the first data to writing the second data in accordance with the command being associated with the starting logical address of the second address mapping table.

6. The memory system of claim 3, wherein the first set of commands is grouped into the first group in accordance with the first set of commands each being associated with a threshold data size.

7. The memory system of claim 3, wherein the processing circuitry is further configured to cause the memory system to:
store, until the threshold amount of first data is written to the set of sequential physical addresses, the second data in a local memory in accordance with the second set of commands being grouped into the second group.

8. The memory system of claim 1, wherein the compressed version of the address mapping table comprises an indication that the address mapping table is compressed, comprises a physical address for a numerically first logical address associated with the address mapping table, and excludes physical addresses for a remainder of logical addresses associated with the address mapping table.

9. The memory system of claim 1, wherein the address mapping table is associated with an amount of data, and wherein the threshold amount of first data is equal to the amount of data associated with the address mapping table.

10. The memory system of claim 1, wherein a first command of the first set of commands is received before a second command of the second set of commands, and wherein data associated with the first command is written before data associated with the second command is written.

11. The memory system of claim 1, further comprising:
write, to the memory system, additional first data associated with the first set of commands in response to writing the second data.

12. A memory system, comprising:
one or more non-volatile memory devices; and
processing circuitry coupled with the one or more non-volatile memory devices and configured to cause the memory system to:
receive a first set of commands and a second set of commands that are interspersed with the first set of commands, the first set of commands associated with a set of sequential logical addresses;
issue the first set of commands to a memory device before the second set of commands in accordance with the first set of commands being associated with the set of sequential logical addresses;
write, in response to issuing the first set of commands, a threshold amount of first data associated with the first set of commands to a set of sequential physical addresses in the memory device;
write second data associated with the second set of commands in response to issuing the second set of commands; and
generate, in response to writing the threshold amount of first data to the set of sequential physical addresses, a compressed version of an address mapping table associated with the set of sequential logical addresses associated with the first set of commands.

13. The memory system of claim 12, wherein the processing circuitry is further configured to cause the memory system to:
group the first set of commands into a first group, wherein the first set of commands are issued in accordance with being included in the first group; and
group the second set of commands into a second group, wherein the second set of commands is issued in accordance with being included in the second group.

14. The memory system of claim 13, wherein the first set of commands is grouped into the first group in accordance with the first set of commands being associated with the set of sequential logical addresses.

15. The memory system of claim 13, wherein the first set of commands is grouped into the first group in accordance with the first set of commands each being associated with a threshold data size.

16. The memory system of claim 13, further comprising:
storing, until the threshold amount of first data is written to the set of sequential physical addresses, the second data in a local memory in accordance with the second set of commands being grouped into the second group.

17. The memory system of claim 12, wherein the compressed version of the address mapping table comprises an indication that the address mapping table is compressed, and comprises a physical address for a numerically first logical address associated with the address mapping table.

18. The memory system of claim 12, wherein the address mapping table is associated with an amount of data, and wherein the threshold amount of first data is equal to the amount of data associated with the address mapping table.

19. The memory system of claim 12, wherein a first command of the first set of commands is received before a second command of the second set of commands, and wherein the first command is issued before the second command is issued.

20. The memory system of claim 12 wherein the processing circuitry is further configured to cause the memory system to:
write, to the memory device, additional first data associated with the first set of commands in response to writing the second data.

21. A method, comprising:
receiving a first set of commands and a second set of commands that are interspersed with the first set of commands, the first set of commands associated with a set of sequential logical addresses;
writing, in accordance with the first set of commands being associated with the set of sequential logical addresses, a threshold amount of first data associated with the first set of commands to a set of sequential physical addresses in a memory system;
writing second data associated with the second set of commands in response to writing the threshold amount of first data; and
generating, in response to writing the threshold amount of first data to the set of sequential physical addresses, a compressed version of an address mapping table associated with the set of sequential logical addresses associated with the first set of commands.

22. The method of claim 21, further comprising:
grouping the first set of commands into a first group; and
grouping the second set of commands into a second group, wherein the first set of commands are issued before the second set of commands.

23. The method of claim 22, wherein the first set of commands is grouped into the first group in accordance with the first set of commands being associated with the set of sequential logical addresses.

24. The method of claim 22, wherein the first set of commands is grouped into the first group in accordance with the first set of commands each being associated with a threshold data size.

25. The method of claim 21, further comprising:
determining whether a command of the first set of commands is associated with a starting logical address of a second address mapping table; and
switching, before writing data associated with the command, from writing the first data to writing the second data in accordance with the command being associated with the starting logical address of the second address mapping table.
